(19) United States
(12) Patent Application Publication
(10) Pub. No.: US 2026/0254557 A1
(43) Pub. Date: Aug. 27, 2026

(54) SYSTEMS AND METHODS FOR PROVIDING DYNAMIC DATA RATES THROUGH DYNAMIC HEADER ENCODING

(71) Applicant: Qorvo US, Inc., Greensboro, NC (US)

(72) Inventors: Billy Verso, Maynooth (IE); Jaroslaw Niewczas, Jozefow (PL)

(21) Appl. No.: 18/996,021

(22) PCT Filed: Jul. 31, 2023
(86) PCT No.: PCT/US23/29083

§ 371 Date: Jan. 17, 2025

Related U.S. Application Data
(60) Provisional application No. 63/403,920, filed on Sep. 6, 2022.
(60) Provisional application No. 63/458,979, filed on Apr. 13, 2023.

(51) Int. Cl. H04L 1/00; H04B 1/7163; H04L 69/22

(52) U.S. Cl. CPC H04L 1/0011; H04B 1/7163; H04L 69/22

(57) ABSTRACT

Systems and methods for providing dynamic data rates through dynamic header encoding are disclosed. In one aspect, a header for a data packet may be split into multiple parts, with a first part having a data rate encoded therein being sent at a first, slow data rate, with a remainder of the header being sent at a higher date indicated by the encoded data from the first part. By providing the data rate early in the packet header and then switching to a higher rate for the remainder of the header, the length of time required to transmit the header may be reduced. Since less time is required to the send the header, the data transmission is shorter, allowing the device to enter an inactive state so as to allow entry into a low-power mode.

### PRIORITY CLAIMS

The present application claims priority to U.S. Provisional Patent Application Ser. No. 63/458,979, filed on Apr. 13, 2023, and entitled “SYSTEMS AND METHODS FOR PROVIDING DYNAMIC DATA RATES THROUGH DYNAMIC HEADER ENCODING,” the contents of which are incorporated herein by reference in its entirety.

The present application also claims priority to U.S. Provisional Patent Application Ser. No. 63/403,920, filed on Sep. 6, 2022, and entitled “OPTIMIZED PHYSICAL LAYER HEADER FOR DYNAMIC MODULATION RATES,” the contents of which are incorporated herein by reference in its entirety.

### BACKGROUND

### I. Field of the Disclosure

The technology of the disclosure relates generally to headers that may be used to signal data rates and, more particularly, to headers used in ultra-wideband (UWB) communication protocols and even more particularly to a physical layer used by such protocols.

### II. Background

Computing devices abound in modern society, and more particularly, mobile communication devices have become increasingly common. The prevalence of these mobile communication devices is driven in part by the many functions that are now enabled on such devices. Increased processing capabilities in such devices means that mobile communication devices have evolved from pure communication tools into sophisticated mobile entertainment centers, thus enabling enhanced user experiences. With the advent of the myriad functions available to such devices, there has been increased pressure to find ways to reduce power consumption. One way power may be saved is through minimizing activity in a device such that inactive components or elements can be put into a low-power or sleep mode. Finding ways to reduce the amount of time that an element such as a transceiver is active provides room for innovation.

### SUMMARY

Aspects disclosed in the detailed description include systems and methods for providing dynamic data rates through dynamic header encoding. In particular, a header for a data packet may be split into multiple parts, with a first part having a data rate encoded therein being sent at a first data rate, with a remainder of the header being sent at a second rate indicated by the encoded data from the first part. In most cases, the second rate may be faster than the first rate. By providing the data rate early in the packet header and then switching to a higher rate for the remainder of the header, the length of time required to transmit the header may be reduced. Since less time is required to send the header, the data transmission is shorter, allowing the device to enter an inactive state to allow entry into a low-power mode. Even if the second rate is slower than the first, the flexibility afforded by having the ability to indicate a dynamic data rate may provide additional advantages.

In this regard, in one aspect, a transceiver is disclosed. The transceiver comprises an output configured to be coupled to an antenna, a control circuit coupled to the output and configured to assemble a packet having a physical layer (PHY) header (PHR) comprising a first part containing data rate information and a second part having additional information, send the first part of the PHR at a first low-speed data rate, and send the second part of the PHR at a second data rate equal or faster than the first low-speed data rate and corresponding to the data rate information.

In another aspect, a method of transmitting a packet is disclosed. The method comprises sending a first part of a PHY PHR at a first slow data rate and sending a second part of the PHR at a second faster data rate indicated by data in the first part.

### BRIEF DESCRIPTION OF THE DRAWINGS

FIG. 1A is a stylized diagram of an exemplary wireless environment with two wireless communication devices communicating with one another wirelessly;

FIG. 1B is a block diagram of one of the wireless communication devices of FIG. 1A;

FIG. 2 is a block diagram of a data packet structure that may be used to send and receive data in the wireless environment of FIG. 1A;

FIG. 3 is a block diagram of a conventional physical layer (PHY) header that may be used in the data packet structure of FIG. 2 in an ultra-wideband (UWB) wireless environment;

FIG. 4 is a block diagram of a PHY header according to an exemplary aspect of the present disclosure where a first part of the PHY header may indicate a data rate (and possibly another data rate) and be sent at a first speed with a remainder of the PHY header being sent at the rate indicated by the data rate(s) in the first part of the PHY header;

FIG. 5 is a block diagram of a PHY header according to an alternate aspect of the present disclosure where a second part of the PHY header is sent at a rate indicated by a first part, and a payload is sent at a third rate indicated by the second part of the PHY header;

FIG. 6A is a flowchart illustrating an exemplary process for sending a dynamic data rate through a dynamic header according to an aspect shown in FIG. 4;

FIG. 6B is a flowchart illustrating an exemplary process for sending a dynamic data rate through a dynamic header according to an aspect shown in FIG. 5; and

FIG. 7 is a block diagram of a mobile terminal, which may include the dynamic headers of FIGS. 4 and 5 according to the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that although the terms first, second, etc. may be used herein to describe various elements, these elements should not be limited by these terms. These terms are only used to distinguish one element from another. For example, a first element could be termed a second element, and similarly, a second element could be termed a first element without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element, or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element, or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description include systems and methods for providing dynamic data rates through dynamic header encoding. In particular, a header for a data packet may be split into multiple parts, with a first part having a data rate encoded therein being sent at a first data rate, with a remainder of the header being sent at a second rate indicated by the encoded data from the first part. In most cases, the second rate may be faster than the first rate. By providing the data rate early in the packet header and then switching to a higher rate for the remainder of the header, the length of time required to transmit the header may be reduced. Since less time is required to send the header, the data transmission is shorter, allowing the device to enter an inactive state to allow entry into a low-power mode. Even if the second rate is slower than the first, the flexibility afforded by having the ability to indicate a dynamic data rate may provide additional advantages.

There are many wireless communication environments. While the present disclosure will focus, for the sake of illustration, on a wireless communication environment defined by IEEE 802.15.4a, IEEE 802.15.4z, and 802.15.4ab, which operate in the so-called ultra-wideband (UWB), aspects of the present disclosure may be useful in other wireless communication environments, and the disclosure is not limited to the UWB environment.

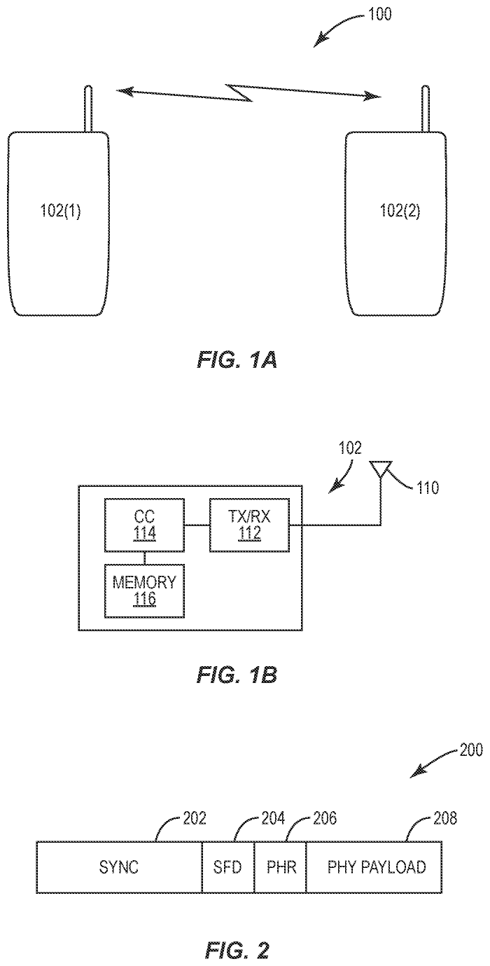

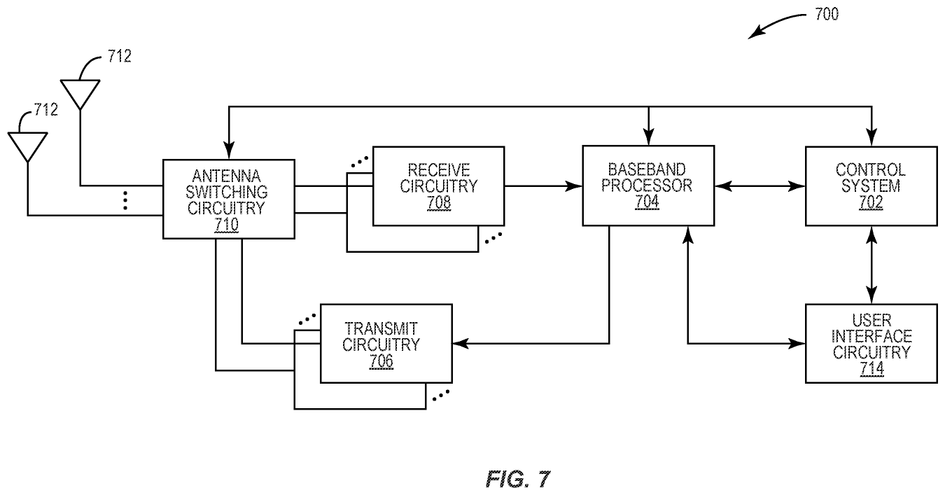

In this regard, FIG. 1A is a stylized diagram of an exemplary wireless environment 100 with two wireless communication devices 102(1) and 102(2), communicating with one another wirelessly through a communication protocol such as IEEE 802.15.4a, IEEE 802.15.4z, or 802.15.4ab. FIG. 1B is a block diagram of one of the wireless communication devices 102 of FIG. 1A. This wireless communication device 102 may include an antenna 110, a transceiver 112, a control circuit 114, and a memory 116. Other elements may be present, and additional details about the transceiver 112 may be found below with reference to FIG. 7. Likewise, while aspects of the present disclosure specifically contemplate a wireless protocol, such as the various IEEE 802.15.4 standards, aspects of the present disclosure could be used in a wire-based environment if needed or desired.

FIG. 2 is a block diagram of a data packet structure 200 that may be used to send and receive data in the wireless environment 100 and specifically complies with the 802.15.4z and 802.15.4ab standards. The data packet structure 200 includes a synchronization (SYNC) field 202, a start of frame delimiter (SFD) field 204, a physical layer (PHY) header (PHR) 206, and a PHY payload 208.

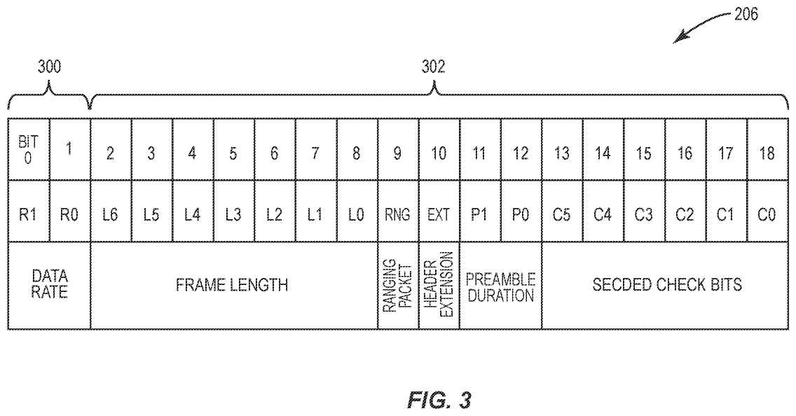

A version of a PHR 206 compliant with IEEE 802.15.4a is more fully illustrated in FIG. 3, where a data rate field 300 may be provided in early bits of the PHR 206, and several other bits 302 are provided to define frame length, ranging packet, header extensions, preamble duration, and other bits. The two bits in the data rate field 300 would indicate a data rate of the payload 208 that followed the PHR 206. More specifically, in IEEE 802.15.4a, the two bits encoded 110 kilobits per second (kb/s) 850 kb/s, 6.8 megabits per second (Mb/s) or 27 Mb/s. While there was some ability to provide dynamic data rates in this early protocol, the PHR 206 was maintained at a constant data rate, and the dynamic flexibility was limited to the payload 208.

IEEE 802.15.4z added additional data rates, including 7.8 Mb/s and 31.2 Mb/s, but moved away from the ability to provide dynamic data rate changes indicated in the PHR by removing the data rate field 300 from the PHR 206. That is, in 802.15.4z, a single data rate was pre-negotiated and then used between the transmitter and receiver. Data rates for the PHR were also pre-negotiated and could be either the same as the data rate for the payload or, in some instances, fifty percent of the data rate for the payload.

More recently, a task group working on IEEE 802.15.4ab has proposed even higher data rates 62.4 Mb/s and 124.8 Mb/s as well as a slow 1.95 Mb/s data rate. The new data rates can be used statically (that is, after pre-negotiation); however, there are scenarios where being able to change the data rate very quickly is beneficial (for example, in reaction to changing channel conditions), and doing so by signaling the rate in the PHR is elegant and fast. To support dynamic data rate changes, a constant rate PHR could indicate the data mode rate. However, the PHR should be transmitted in such a way that it is more robust than the most robust (lower rate) data mode option. The strongest data mode option here is 1.95 Mb/s. However, if advanced coding is used for the data, this coding will make the payload additionally strong, requiring the PHR to be transmitted at an even lower rate, possibly 0.975 Mb/s or slower. At 0.975 Mb/s, a 20-bit PHR is expected to have a twenty (20) microseconds duration. This time represents a significant overhead when compared to typical preamble and payload lengths, especially when data is being transmitted at the higher data rates. These new data rates create opportunities for improvement in optimizing use of dynamic data rates between different portions of signals. Finding a way to shorten this PHR transmission time to reenter the low-power sleep/standby modes sooner represents an opportunity for substantial power savings. Additionally, shorter packet durations may also reduce the chance of packet interference, reduce the risk of collision, and/or provide additional benefits.

Exemplary aspects of the present disclosure contemplate breaking the PHR into at least two parts, where a first part provides encoded data rate information in relatively few bits but at a slow data rate. Subsequent parts of the PHR are sent at a second data rate indicated by the first part. In most cases, the second data rate will be higher than the first data rate, thereby shortening the temporal length of the PHR. Shortening the PHR creates power-saving opportunities, reduced interference, and reduced collisions. Even where the second data rate is the same (or perhaps even slower) than the first rate, having the flexibility to change data rates dynamically provides more design options and thus may have other advantages.

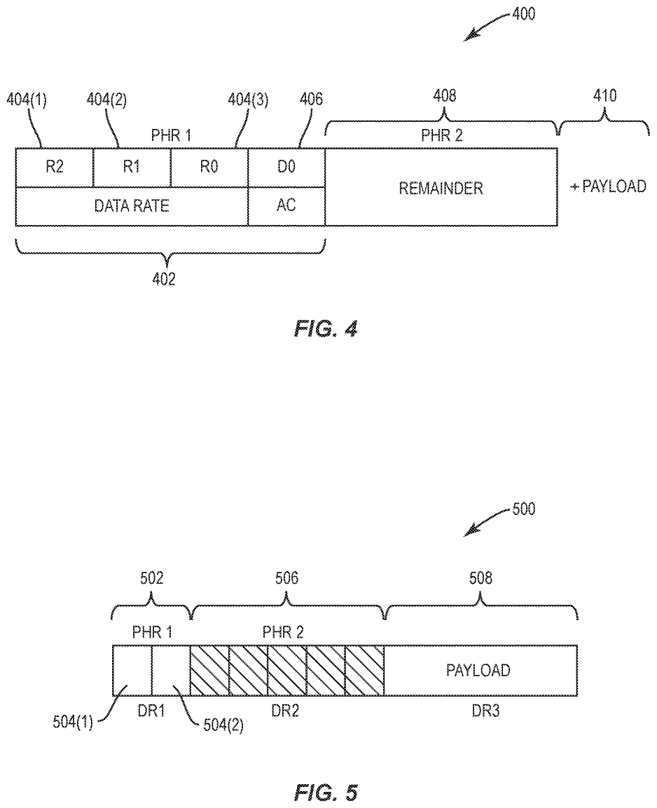

In a first aspect, the PHR is transmitted in two parts, as illustrated in FIG. 4. Specifically, a PHR 400 has a first part 402 (PHR1) (sometimes referred to as a rate header) that includes three bits 404(1)-404(3) (R2−R0) that carry an encoded data rate. A fourth bit 406 is an advanced coding (AC) bit. An exemplary coding might be low-density parity-check (LDPC), which is used for the payload 410. The first part 402 provides an indication of what data rate(s) will be used to transmit a second part 408 (sometimes referred to as a main header) and a payload 410 (if the payload 410 is present). As further explained below, this indication may be an explicit data rate code or encoded in combination with another bit, such as the AC bit. The second part 408 may include information such as payload length, ranging and/or sensing information, cyclic redundancy check (CRC) bits, and other information as needed or desired.

There may be a temporal pause (also referred to as a guard interval) between the first part 402 and the second part 408, so these parts need not be immediately adjacent to one another temporally. This pause may allow a receiver to reconfigure for any new data rate indicated within the first part 402. This pause may, strictly speaking, not be necessary, and the precise amount of time is not material to the present disclosure. Note also that the bits of the first part 402 may be modulated and/or scrambled with a spreading code (or other technique) without departing from the present disclosure.

Note that if the AC bit (i.e., fourth bit 406) is set and signals an advanced coding is being employed for the payload 410, the second part 408 with a convolutional code could be a weak point versus the strength of the payload 410. Thus, the presence of the AC bit being set may also signal modulation of the second part 408 at a lower effective rate (e.g., half of the data rate signaled by bits 404(1)-404(3)) by, for example, sending each bit in the second part 408 twice or with a double size symbol compared to a data payload symbol size. This doubling improves the robustness of the second part 408 to match the performance of the robustness of the payload 410, such as when the payload is LDPC encoded.

Note further that by having this lower effective rate for the second part 408, there are effectively three data rates (e.g., a first rate corresponding to the first part 402, a second rate corresponding to the second part 408, and a third rate corresponding to the payload 410). However, it should be appreciated that the second rate is dependent on the third rate, so only the third rate needs to be explicitly indicated in the first part 402. Note still further that the use of the ordinal terms first, second, and third are not dispositive or necessarily indicative of order but are merely used for convenience to differentiate between the different rates.

In other aspects, the first part 402 could be reduced to just three bits, and the AC bit could be in the second part 408 (or removed entirely). If the AC bit is removed, there is no indication as to how strong the payload 410 is. This lack of knowledge may not matter in some implementations. More likely, however, is that the AC bit may be moved to the second part so that the strength of the payload is known, just not provided in PHR1. Note also that after encoding or mapping (where redundancy is used for better performance) the first part 402 may be more than four bits, and may, for example, be a twenty-bit codeword which maps to a particular combination of data rate and LDPC coding.

In contrast to the first aspect illustrated in FIG. 4, a second aspect contemplates having multiple independent data rates across different portions of the PHR and payload. For example, there may be a rate header having a first rate, a main header having a second rate determined from the rate header, and a payload with yet a third rate determined from the main header (as opposed to a second rate being dependent on a third rate as described above). An exemplary PHR 500 according to this aspect is provided in FIG. 5. Specifically, the PHR 500 includes a first part 502 with two bits 504(1)-504(2). The first part 502 is sent at a first speed (data rate 1 or DR1), and the bits 504(1)-504(2) signal what data rate (DR2) is used to send a second part 506. The second part 506 may include bits that signal what data rate (DR3) is used for a payload 508. This approach reduces the number of bits sent at the slowest rate to just two bits but limits how many rates are available for the second part 506 (because there are only two bits, only four rates may be identified), but still allows the second part 506 to be sent at a relatively high data rate. The payload 508 may then be sent at even higher data rates if desired if so indicated within the second part 506. While it is contemplated that the data rates increase across the parts and payload, the present disclosure is not so limited. There may be instances where the second rate is the same as or slower than the first rate, or the third rate is slower than the second rate. More likely, however, the third data rate is the same as the second rate or twice as fast as the second data rate. Likewise, coding schemes may support slower rates in the second part 506, or the payload 508.

Where the aspect illustrated by FIG. 4 contemplates that the rate indicated by the rate header 402 determines the rate used by both the second part 408 and the payload 410, in the approach illustrated in FIG. 5 requires multiple dynamic adjustments of data rates, which may add to the complexity of the receiver and have offsetting undesirable characteristics, but it is an option and may be a suitable approach for some systems.

Still another aspect may be used. This third aspect differs in implementation but does achieve support for dynamic rate PHR and data without suffering an overhead of slow and long PHR and without needing out-of-band signaling. In this third aspect, PHR is not split into parts. Instead of parts, the PHR is transmitted as a whole. This aspect relies on sending the entirety of the PHR at a first data rate (typically the highest rate to be supported) but repeating the PHR a number of times depending on the robustness needed for the target payload data rate. If this payload data rate is low, then the PHR may be repeated more times to match performance, and where the data rate is high, the PHR may be repeated fewer times. In an exemplary aspect, a highest second data rate may have the fewest repetitions, and the slowest second data rate may have the most repetitions. The receiver does not know the final payload data rate or the number of incoming repetitions. Thus, the receiver first begins trying to receive and decode a PHR at a base data rate. If the receiver succeeds (e.g., it gets a good CRC check result), the receiver examines the received PHR-rate bits and knows whether there will be more repetitions of the PHR and what the payload data rate will be. Additional repetitions can be ignored or processed. If the first check fails, each repeated PHR adds the repeated symbols to the first symbols received, and the sum of the sequences is decoded again. This process is repeated until a good CRC is found, and a determination can be made if there will be more repetitions. If the CRC is wrong through all repetitions, the PHR reception fails. Thus, if a high data rate is used, the PHR is transmitted once (at a highly effective data rate), resulting in low overhead. If data rates are slow, then repeated PHR are sent, and the PHR performance is improved to match that of the data mode.

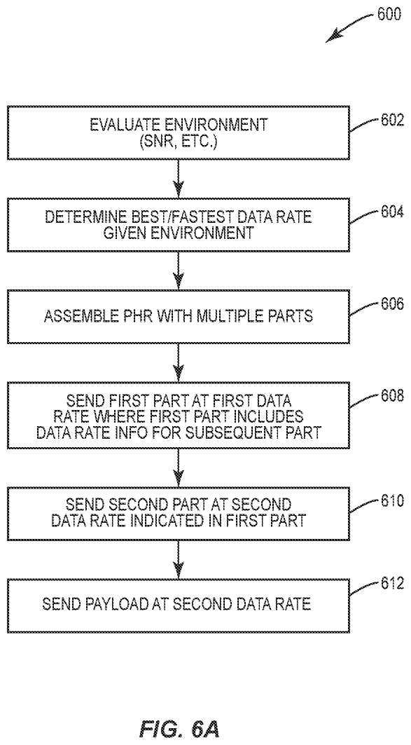

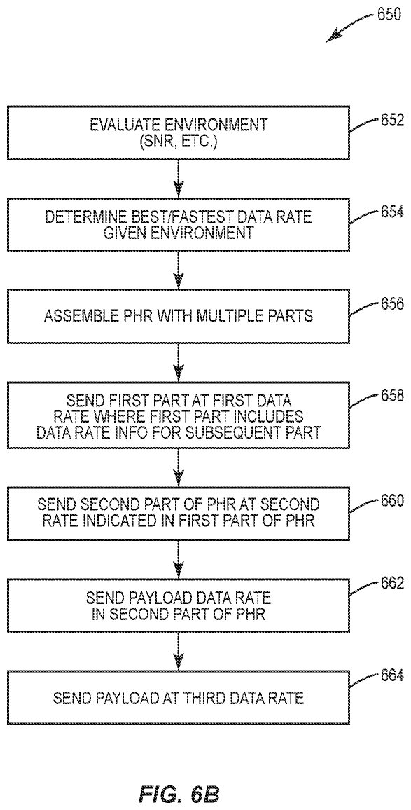

FIG. 6A is a flowchart illustrating an exemplary process 600 for sending a dynamic data rate through a dynamic header according to aspects of the present disclosure. In particular, the process 600 begins by evaluating an environment for signal-to-noise ratio (SNR) (block 602) or other metrics, including but not limited to estimated channel state (e.g., how much multipath), frame error rate in previous packets, estimated speed of movement between devices, estimated interference level, and whether an in-use application has specific requirements relating to error rates. This may be done by a control circuit (e.g., control circuit 114) of a wireless communication device. As the evaluated metrics indicate, the control circuit 114 may further determine a best or fastest data rate supported given the environment (block 604).

The control circuit 114 may then assemble a PHR with multiple parts (block 606) and send the first part at a first data rate, where the first part includes data rate information for a subsequent part or parts (block 608). As explained above, the data rate information may include explicit information for a payload data rate and also include coding information that inferentially indicates a data rate for a second part of the PHR. In some cases, the payload data rate and the data rate for the second part of the PHR are the same. The control circuit 114 may then send the second part at a second data rate, as indicated in the first part (block 610) (either explicitly or inferentially based on the coding information). Finally, the control circuit 114 may send the payload at the second data rate (block 612). In most use cases, the second rate is faster than the first rate, but the present disclosure is not so limited.

Note that in instances where the second part 408 is sent at a data rate half that of the data rate of the payload 410 (e.g., when the AC bit 406 indicates that encoding is of a robustness where a slower data rate is appropriate for the second part 408), there may, in fact, be three data rates, but it should still be appreciated that the data rate for the second part 408 and the payload 410 are dispositively indicated by the first part 402.

While FIG. 6A corresponds to the aspect illustrated by FIG. 4, FIG. 6B provides a flowchart illustrating an exemplary process 650 corresponding to the aspect illustrated by FIG. 5. In particular, the process 650 begins by evaluating an environment for signal-to-noise ratio (SNR) (block 652) or other metrics, including but not limited to estimated channel state (e.g., how much multipath), frame error rate in previous packets, estimated speed of movement between devices, estimated interference level, and whether an in-use application has specific requirements relating to error rates. This may be done by a control circuit (e.g., control circuit 114) of a wireless communication device. As the evaluated metrics indicate, the control circuit 114 may further determine a best or fastest data rate supported given the environment (block 654).

The control circuit 114 may then assemble a PHR with multiple parts (block 656) and send the first part at a first data rate, where the first part includes data rate information for a subsequent part (block 658). The control circuit 114 may then send the second part at a second data rate, as indicated in the first part (block 660). By sending the second part at the second data rate, the control circuit 114 may also be sending a payload data rate in the second part (block 662). Finally, the control circuit 114 may send the payload at the second data rate (block 664). In most use cases, the second rate and the payload data rate are faster than the first rate, but the present disclosure is not so limited.

It should be appreciated that the present disclosure contemplates sending a first part of the PHR at a first, likely predetermined data rate and then sending a second part of the PHR at a second data rate indicated by the first part. While most benefit is provided when the second data rate is higher than the first part, such is not strictly required. Table 1 summarizes the possible data rate combinations for the first aspect under current proposals of IEEE 802.15.4ab, where an AC bit maps to whether LDPC is enabled.

TABLE 1

| LDPC enabled | [symbol] HR2 bit rate (Mb/s) | PSDU bit rate (Mb/s) |
|---|---|---|
| Yes | 0.975 | 1.95 |
| No | 1.95 | 1.95 |
| Yes | 3.9 | 7.8 |
| No | 7.8 | 7.8 |
| Yes | 15.6 | 31.2 |
| No | 31.2 | 31.2 |
| Yes | 31.2 | 62.4 |
| No | 62.4 | 62.4 |
| Yes | 62.4 | 124.8 |
| No | 124.8 | 124.8 |

[symbol]

indicates data missing or illegible when filed

Also, while a specifically contemplated approach is to put modulation and coding information (sometimes referred to as a modulation and coding scheme), the presence of coding information is optional in some aspects of the present disclosure.

A more detailed description of the workings of the wireless environment 100 is provided with reference to FIG. 7. Specifically, with reference to FIG. 7, the concepts described above may be implemented in various types of wireless devices, generically referred to as user elements 700, such as mobile terminals, smart watches, tablets, computers, navigation devices, access points, and like wireless communication devices that support wireless communications, such as cellular, wireless local area network (WLAN), UWB, Bluetooth, and near field communications. The user elements 700 will generally include a control system 702, a baseband processor 704, transmit circuitry 706, receive circuitry 708, antenna switching circuitry 710, multiple antennas 712, and user interface circuitry 714. In a non-limiting example, the control system 702 can be a field-programmable gate array (FPGA) or an application-specific integrated circuit (ASIC), as an example. In this regard, the control system 702 can include at least a microprocessor(s), an embedded memory circuit(s), and a communication bus interface(s). The receive circuitry 708 receives radio frequency signals via the antennas 712 and through the antenna switching circuitry 710 from one or more base stations. A low noise amplifier and a filter of the receive circuitry 708 cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converter(s) (ADC).

The baseband processor 704 processes the digitized received signal to extract the information or data bits conveyed in the received signal. This processing typically comprises demodulation, decoding, and error correction operations, as will be discussed in greater detail below. The baseband processor 704 is generally implemented in one or more digital signal processors (DSPs) and application-specific integrated circuits (ASICs).

For transmission, the baseband processor 704 receives digitized data, which may represent voice, data, or control information, from the control system 702, which it encodes for transmission. The encoded data is output to the transmit circuitry 706, where a digital-to-analog converter(s) (DAC) converts the digitally encoded data into an analog signal, and a modulator modulates the analog signal onto a carrier signal that is at a desired transmit frequency or frequencies. A power amplifier will amplify the modulated carrier signal to a level appropriate for transmission and deliver the modulated carrier signal to the antennas 712 through the antenna switching circuitry 710 to the antennas 712. The multiple antennas 712 and the replicated transmit and receive circuitries 706, 708 may provide spatial diversity. Modulation and processing details will be understood by those skilled in the art.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using various technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

1. A transceiver comprising:
an output configured to provide an output signal;
a control circuit coupled to the output and configured to:
assemble a packet having a physical layer (PHY) header (PHR) having a first part and a second part;
send the first part of the PHR at a first data rate; and
send the second part of the PHR at a second data rate indicated by the first part; and
transmit circuitry controlled by the control circuit and configured to operate at an ultra-wideband (UWB) frequency.

2. The transceiver of claim 1, wherein the control circuit is configured to assemble the packet having the PHR with the first part, wherein the first part comprises at least modulation information.

3. The transceiver of claim 1, wherein the control circuit is configured to assemble the packet having the PHR with the first part, wherein the first part comprises modulation and coding information.

4. The transceiver of claim 3, wherein the coding information comprises an advanced coding specifier.

5. The transceiver of claim 1, wherein the control circuit is configured to assemble the packet having the PHR with the first part, wherein the first part comprises at most four bits.

6. (canceled)

7. The transceiver of claim 1, wherein the control circuit is further configured to send a payload after the second part.

8. The transceiver of claim 7, wherein the control circuit is further configured to send the payload at the second data rate indicated in the first part.

9. The transceiver of claim 7, wherein the control circuit is further configured to send the payload at a third data rate equal to or twice as fast as the second data rate.

10. The transceiver of claim 9, wherein the control circuit is configured to assemble the packet having the PHR with the first part, wherein the first part comprises modulation and coding information and wherein the coding information indicates the third data rate.

11. The transceiver of claim 1, wherein the control circuit is configured to determine the second data rate based on environmental metrics.

12. The transceiver of claim 11, wherein the environmental metrics are selected from the group consisting of: signal to noise ratio, estimated channel state, frame error rate of previous packets, estimated speed of movement of the transceiver, and estimated interference level.

13. The transceiver of claim 1, wherein the control circuit is further configured to send additional information in the second part.

14. The transceiver of claim 13, wherein the additional information comprises data rate information used to indicate a third data rate used by a payload portion of the packet.

15. The transceiver of claim 14, wherein the control circuit is configured to send the payload using the third data rate.

16. A method of transmitting a packet comprising:
sending a first part of a physical layer (PHY) header (PHR) at a first data rate; and
sending a second part of the PHR at a second data rate indicated by modulation information in the first part; and
wherein sending the first part of the PHR comprises sending using transmit circuitry configured to operate at an ultra-wideband (UWB) frequency.

17. The method of claim 16, further comprising determining the second data rate by evaluating environmental conditions.

18. The method of claim 16, further comprising sending a payload at the second data rate.

19. The method of claim 16, wherein sending the first part comprises sending two or three bits indicating the second data rate.

20. The method of claim 16, wherein sending the first part comprises sending an advanced coding bit.

21-22. (canceled)
